(19) United States
(12) Patent Application Publication
(10) Pub. No.: US 2022/0358100 A1
(43) Pub. Date: Nov. 10, 2022

(54) PROFILE DATA EXTENSIONS

(71) Applicant: MICROSOFT TECHNOLOGY LICENSING, LLC, Redmond, WA (US)

(72) Inventors: Michael Dean LUCARELLI, Sammamish, WA (US); Sheetal BERG, Redmond, WA (US); Mukti Nikhil DESAI, Seattle, WA (US); Srisaipavan VALLURI, Redmond, WA (US); Ayyappan BALASUBRAMANIAN, Redmond, WA (US); Shalini BALASUBRAMONIAN, Kirkland, WA (US); Jack Micle PULLIKOTTIL, Redmond, WA (US)

(73) Assignee: MICROSOFT TECHNOLOGY LICENSING, LLC, Redmond, WA (US)

(21) Appl. No.: 17/307,540

(22) Filed: May 4, 2021

(51) Int. Cl. G06F 16/21; G06F 16/9035; G06F 16/22; G06F 9/448; H04L 29/08

(52) U.S. Cl. CPC G06F 16/212; G06F 16/9035; G06F 16/2282; G06F 9/4492; H04L 67/306

(57) ABSTRACT

A method for providing generating data extensions for a first data profile includes receiving a request for historical data, the data being associated with a first data profile, the first data profile being generated from data supplied by a data source system, creating a data model for obtaining the historical data based on data from at least one of the first data profile, a second data profile, or the data source system, executing the data model to obtain the historical data, and storing the historical data as a data extension of the first data profile. The first data profile and the data extension of the first data profile may be generated and stored separately, and the data extension of the first data profile is generated on the fly at runtime.

### TECHNICAL FIELD

This disclosure relates generally to data profile extensions, and, more particularly, to an improved method of and system for managing, storing and utilizing data profiles.

### BACKGROUND

In recent years, data has become an important aspect of various business fields. These businesses often collect, manage, utilize, sell and/or buy data. As a result, collection, management, tracking, organizing, and validating of data has become significantly important. Furthermore, the amount of data collected, stored, managed and/or analyzed in various fields is often significantly large and includes many different types of data. To make use of all the available data, organizations often organize data received from various sources by profile. A data profile may include a few base data fields that have static properties, as well as many other data fields with dynamic properties that change over time. As a result, a typical data profile includes many different data fields, and is thus large in size. Furthermore, because data is collected and stored for many entities (e.g., users, organizations, devices, applications, etc.), the number of data profiles is often large. To keep track of changes in data and maintain historical information, many organizations create and store daily snapshots of their data profiles. With the number of data fields stored for each profile and the often significantly large number of profiles for which data is stored, the process of creating daily snapshots utilizes a significant amount of computer processing, memory and/or bandwidth.

Furthermore, data environments often need to perform restatement of data. Restatement occurs when one or more data streams or datasets are reprocessed (e.g., reproduced) for a given time period. Restatement may be needed when data is updated, a failure occurs, data inaccuracies are detected and/or upon a feature change in a profile. Data profiles often depend on one another. For example, one type of profile uses data streams from another type of profile to generate its data. As a result, a restatement in one data profile may affect its dependent profiles. In a large and complex data environment, this may result in numerous other restatements being needed. Restatements need to occur in order, may take a long time and may utilize significant computer resources. Thus, a simple error or feature change may take a long time to process and effectuate. As a result, current methods of managing data profiles are time consuming, resource intensive and inefficient.

Hence, there is a need for improved systems and methods for managing, storing and utilizing data profiles.

### SUMMARY

In one general aspect, the instant disclosure describes a data processing system having a processor, and a memory in communication with the processor where the memory comprises executable instructions that, when executed by the processor, cause the data processing system to perform multiple functions. The functions may include receiving a request for historical data, the data being associated with a first data profile, the first data profile being generated from data supplied by a data source system, responsive to the received request, creating a data model for obtaining the historical data based on data from at least one of the first data profile, a second data profile, or the data source system, executing the data model to obtain the historical data, and storing the historical data as a data extension of the first data profile, wherein the first data profile and the data extension of the first data profile are generated and stored separately, and the data extension of the first data profile is generated dynamically at runtime.

In yet another general aspect, the instant disclosure describes a method for providing generating data extensions for a first data profile, where the method includes the steps of receiving a request for historical data, the data being associated with a first data profile, the first data profile being generated from data supplied by a data source system, responsive to the received request, creating a data model for obtaining the historical data based on data from at least one of the first data profile, a second data profile, or the data source system, executing the data model to obtain the historical data, and storing the historical data as a data extension of the first data profile, wherein the first data profile and the data extension of the first data profile are generated and stored separately, and the data extension of the first data profile is generated dynamically at runtime.

In a further general aspect, the instant disclosure describes a non-transitory computer readable medium on which are stored instructions that when executed cause a programmable device to receive a request for historical data, the data being associated with a first data profile, the first data profile being generated from data supplied by a data source system, responsive to the received request, create a data model for obtaining the historical data based on data from at least one of the first data profile, a second data profile, or the data source system, execute the data model to obtain the historical data, and store the historical data as a data extension of the first data profile, wherein the first data profile and the data extension of the first data profile are generated and stored separately, and the data extension of the first data profile is generated dynamically at runtime.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example data environment for organizing data.

FIGS. 2A-2B depict example prior art data profiles for storing data.

FIGS. 3A-3B depict example improved data profiles for storing data which implement aspects of this disclosure.

FIG. 4 depicts an example system upon which aspects of this disclosure may be implemented.

FIG. 5 is a flow diagram showing an example method for enabling user of data profile extensions in a data environment.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Most enterprises collect and utilize data for use in many different business fields. The data is often received from a number of source systems and then organized by profile (e.g., user profile, enterprise profile, device profile, etc.). A data profile often includes base profile data information containing basic static data, as well as many more derived profile fields containing dynamic data. As a result, a typical data profile contains many different data fields (e.g., over 100), and as such takes up significant memory space and computer resources to store and process. To make matters worse, enterprises often create and store historical snapshots (e.g., daily snapshots) of their data profiles over time which utilize memory space. Thus, there exists a technical problem of requiring a significant amount of memory, processing, and bandwidth to create, process and/or store historical snapshots of data profiles.

Moreover, data environments often encounter errors, failures, or modifications due to changing business or engineering needs. When a failure or erroneous behavior is detected or an update to a data profile is determined to be needed, the dataset containing the data profile may require restatement. In a large or complex data environment, when multiple datasets depend on one another, restatement of one dataset often necessitates restating many more datasets. This is particularly true when there are interdependencies between different datasets. When data profiles are large, restatements take a lot of time and resources to complete. Furthermore, restatements have to occur sequentially when datasets depend on one another to ensure that accurate data is being used to restate the next dataset. This often means that simple changes in a data environment take a long time to be processed. Thus, there exists another technical problem of inability of current systems to manage data restatements in a data environment in a time and resource efficient, and reliable manner.

To address these technical problems and more, in an example, this description provides a technical solution of utilizing data extensions for collecting, managing, and utilizing data associated with data profiles. To achieve this, a mechanism may be used to utilize extensions to data profiles instead of adding data to the base data profile. The extensions may be generated and stored separately from the data profiles. To achieve this, a data profile extensions infrastructure may be utilized that can receive an indication for a need for a data extension, create a data model for obtaining the required data, evaluate a candidate profile data extension to ensure it complies with required policies and regulations and executes the data model to obtain the required data from a data source and/or from base profile data. This eliminates the need to store substantial amounts of data, create historical snapshots of data, and/or run restatements of data when there is a need for making a change to the underlying data structure.

As will be understood by persons of skill in the art upon reading this disclosure, benefits and advantages provided by such technical solutions can include, but are not limited to, a solution to the technical problems of having inefficient, memory and processing resource intensive data profiles in complex data and computing system environments. Technical solutions and implementations provided herein optimize and improve the process of organizing data associated with a data profile, as such significantly improve optimize and improve operations of computer systems associated with storing and processing large amounts of data. Moreover, the technical solutions provide technical advantages of reducing or eliminating the need for preservation of historical snapshots of data streams, as history can be computed at runtime, reducing or eliminating the need for restatements of data, and implementing changes in business requirements for data profiles by making modifications to data extensions instead of base profiles, thus resulting in timely response to changing business needs.

As used herein, the term “profile” or “data profile” may refer to a dataset associated with an entity and having a data entity key. Moreover, the term “data entity key” may be used to refer to a unique identifier for a data entity. The data entity key may be mastered natively in transaction and provisioning source systems and shared between different computer systems and/or data environments. Additionally, the term “restatement” may refer to reprocessing of one or more portions of data and is sometimes referred to in the art as “backfill.” Moreover, the term “dependent” may be used to refer to a dataset or data profile which receives and uses a data stream from another dataset or system to generate its own data output. The term “downstream” may be used to refer to a dataset that is dependent on another dataset. The term “upstream,” on the other hand, may refer to a dataset on which another dataset depends.

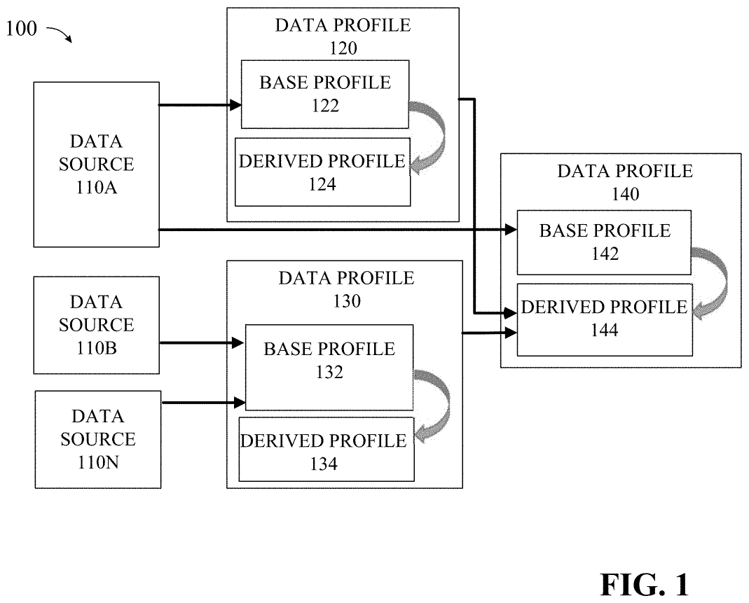

FIG. 1 depicts an example prior art data environment 100. The environment 100 includes a plurality of data source systems 110A-100N. Each of the data source systems may be a source system which collects transactional, telemetry, and/or provisioning data. The data sources may be authoritative for commercial entity identity, user identity, commerce subscriptions, device identity, and/or revenue recognition. In an example, data source systems 110A-100N may include data sources such as Azure® Active Directory (AAD), Microsoft® Account (MSA), commerce, Office® License Service (OLS), device census, and Sales.

The data provided by each of these data sources may be consolidated from different journals, placed in data streams, and federated to various engineering or business teams. For example, the data may be used for business performance measurement, business intelligence and insights, relationship marketing, machine learning models, cloud service optimization, and customer/partner-facing tools and insights.

To provide the data for these various needs, the data provided by the data sources 110A-110N may be organized into various data profiles. Each data profile may represent a different type of entity. These entities may include users (e.g., individuals), enterprises (e.g., tenants), subscriptions (e.g., subscriptions to various software applications), devices, actions, customers, licenses, orders, offers, service plan, SKU and the like. In an example, categories of data profiles include commercial users, commercial tenants, commercial subscription profile, consumer user profile, consumer subscription profile, and device profile.

Data environment 100 includes data profiles 120, 130 and 140. In an example commercial data environment, the data profile 120 may represent user profile data. That is, the data profile 120 may include tabular data streams, where each data stream includes information about a unique user. Each unique user may be identified by a unique data entity key (e.g., a user ID) which serves as the basis for each unique user profile.

Data profile 130 may represent subscription data. That means data profile 130 may include data streams that collect data for subscriptions to various programs (e.g., software applications). Each unique subscription may be identified by a unique data entity key (e.g., a subscription ID) which serves as the basis for the unique subscription profile. Data profile 140, on the other hand, may represent tenant data, which may include data streams for collecting information about enterprises (e.g., enterprises that subscribe to or buy various services, applications and the like from an organization). For example, the tenant data profile 140 may include a data profile for each tenant that has purchased one or more software seats or has subscribed to one or more programs. Each tenant profile may be identified by a unique data entity key such as a tenant ID.

It should be noted that while FIG. 1 depicts one of each of the data profiles 120, 130 and 140, each of the data profiles may represent many such data profiles in the data environment. For example, data profile 120 may represent a data profile for each user in the data environment. A typical enterprise may collect data on thousands or millions of users. Thus, each of the data profiles 120, 130 and 140 may represent thousands or millions of individual data profiles.

Each of the data profiles 120, 130 and 140 may include base profile data and derived profile data. Thus, data profile 120 includes base profile 122 and derived profile 124. Similarly, data profile 130 may include base profile 132 and derived profile 143, while data profile 140 may include base profile 142 and derived profile 144. Each of the base profile 122, 132 and 142 may include basic data about the entity for which it stores data. This may include underlying profile data that is obtained directly from the data sources 110A-110N. In an example, the base profile data is data that remains static for periods of time, and as such, does not change on a daily basis.

In prior data profiles, each data profile also included derived profile data. This is depicted in data environment 100, as derived profile data 124, 134 and 144. The derived profile may include data that is derived or inferred from the base profile or from other data provided by one or more of the data sources 100A-110N. Thus, each of the derived profiles 124, 134 and 144 may include dynamic data that changes overtime. In large data environments that contain significant amounts of data, generating the derived profile data may take a substantial amount of time. In an example, each derived profile data 124, 134 and 144 takes more than 24 hours of processing time. However, some of the derived profile data is dependent on other derived profile data. For example, derived profile 144 receives data from data profile 120, and as such, is dependent on data profile 120. As a result, data profile 140 would need to wait until derived profile 124 has been completed and is ready to be consumed, before it can begin generating its data. In large and complex data environments, where there are multiple layers of dependence, this may lead to substantial amount of time being required to generate or regenerate one or more data profiles in the system.

To ensure historical data was preserved, previous data environments frequently created historical snapshots of one or more types of data profiles in their data environment. In an example, data environment 100 would have generated a daily snapshot for each of the data profiles 120, 130 and 140. As discussed above, each of the data profiles 120, 130 and 140 may include many individual data profiles. Processing data to generate this significant number of historical snapshots required a considerable amount of processing power. Furthermore, significant amount of memory was required to store the generated snapshots. Still further, because of complex dependency and interdependency of data profiles, profile processing often resulted in considerable latency.

Moreover, in the past, restatements of data occurred frequently. One of the common reasons for requiring restatement is existence of incorrect data in a dataset. For example, if a mistake in a logic that produces data profile 120 is detected, the engineering team may decide to correct the logic and regenerate the affected time periods of data for data profile 120. However, because data from data profile 120 is used to produce data profile 140, data profile 140 would also need to be restated. Another example in which a restatement was required in the past, was when there was a change to the definition of one or more derived profile data. In such a case, history would need to be restated to reflect the new definition. As a result, one or more historical snapshots (e.g., all of the historical snapshot for a given time) would require restatement. This resulted in significant processing runtime, computing resources and latency each time a definition would need to be changed. Accordingly, there was a considerable lag time between when a change in business or engineering was needed and when the change to the data was effectuated.

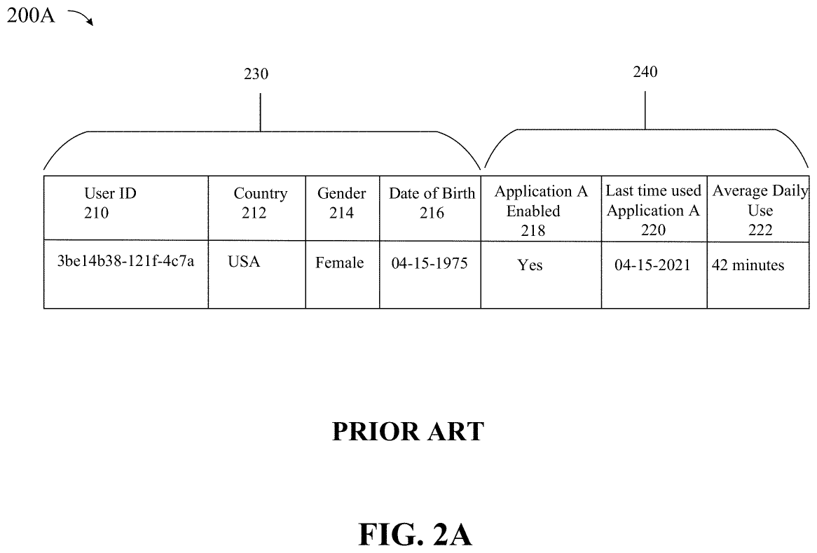

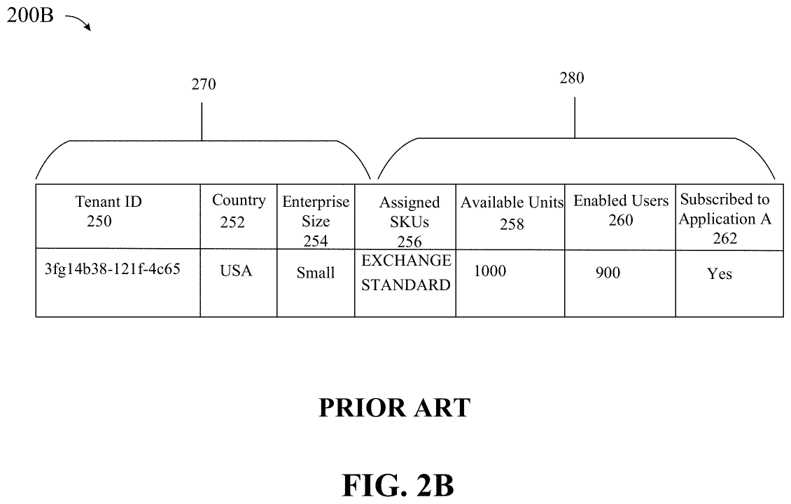

FIGS. 2A-2B depict example prior art data profiles. Data profile 200A of FIG. 2A depicts an example user profile. As shown, the user profile includes a variety of data fields for storing properties. The data fields are depicted as columns and include a user ID 210, country 212, gender 214, date of birth 216, application A enabled 218, last time used application A 220, and average daily use 222. Each of the data fields may include data relating to the field for which information is collected. The user ID field may contain the data entity key associated with each user profile, and as such may contain a unique identifier for each user. The data fields 210, 212 and 214 and 216 may relate to basic information about a user that may be collected from a data source. As such, this portion of the user profile may be referred to as base profile 230. The base profile 230 may include information that is provided by a user and/or for which the user has provided consent. As depicted, the base profile data 230 includes information that is likely to stay static and as such may not require historical snapshots for preservation. It should be noted that in collecting, storing, analyzing and distributing user data, care is taken to ensure that privacy and confidentiality guidelines are followed and met.

Data profile 200A also includes a derived profile data portion 240. The derived profile data portion 240 includes data fields 218, 220, 222. This portion may include data that may be derived and/or inferred from information available in the data source system, from base profile data, and/or from other types of profile data. For example, information about whether application A is enabled for the user may be derived from a subscription profile data or a device profile data. Information about the last time application A was used by the user may be derived from a profile data for Application A. Average daily use 222, on the other hand, may acquire its data from a device profile data. Thus, the derived profile data 240 may depend on other profile data. Furthermore, the derived profile data 240 may require data processing and/or calculation to be generated. Because derived profiled data 240 includes a variety of information, it often includes data that may change over time. To ensure that this information is preserved, prior art data environment often generated and stored historical snapshots of their user profile data.

While profile data 200A includes only four base profile data fields and three derived profile data fields, a real-life user profile may include many more fields. For example, a commonly used user profile data includes 10 base profile fields and over 150 derived profile fields. For a prior art data environment that collects data from over one hundred thousand users, this commonly resulted in generating over a hundred thousand daily snapshots of user profiles each having over 150 fields. This required considerable computer processing resources and substantially increased data processing times.

Data profile 200B of FIG. 2B depicts an example tenant profile. As shown, the tenant profile 200B may include a variety of data fields for storing properties associated with a tenant. The data fields are depicted as columns and include a tenant ID 250, country 252, enterprise size 254, assigned SKUs 256, Available units 258, enabled users 260, and subscribed to application A 262. Each of the data fields may include data relating to the field for which information is collected. The tenant ID field may contain information about the data entity key associated with each tenant profile, and as such may include a unique identifier for each tenant. The country field 250 may contain information about the country in which the tenant is located, and the enterprise size field 254 may contain information about the relative employee size of the tenant (e.g., small, medium or large). The data fields 250, 252, and 254 may relate to basic information about a tenant which may be collected from a data source. As such, this portion of the user profile may be referred to as base profile 270, and may contain information that is relatively static and unlikely to change over a short period of time.

Data profile 200B also includes a derived profile data portion 280. The derived profile data portion 280 includes data fields 256, 258, 260, and 262. The assigned SKUs field 256 may provide the SKUs of software applications for which the tenant has purchased a seat. The available units 258 may represent the number of available units to which the tenant has subscribed (e.g., the tenant has subscribed to 1000 units of Office 360®). The enabled users' field 260 may represent the actual number of users that are enabled by the tenant to use the available units. This occurs when a tenant obtains more units than the current number of employees in expectation of growth. The subscribed to application A field 262 may contain information about whether the tenant is subscribed to a specific application. The information stored in the derived profile data portion 280 may include data that is derived and/or inferred from information available in the data source system, from base profile data, and/or from other types of profile data. For example, information about whether application A is enabled for the tenant may be derived from a subscription profile data or from device profile data. Information about the assigned SKUs may be available from SKU profile data, and so forth. Thus, the derived tenant profile data 280 may depend on other profile data. Furthermore, the derived tenant profile data 280 may require data processing and/or calculation to be generated. Because derived tenant profiled data 280 includes a variety of dynamic information, it often includes data that may change overtime. To ensure that this information is preserved, prior art data environment often generated and stored historical snapshots of their tenant profile data.

Although only three base profile data fields and four derived profile data fields are depicted in FIG. 2B, a typical tenant profile data may include tens or hundreds of fields of properties, most of which may be derived profile data. This results in significant memory and processing needs every time a tenant profile is to be generated or stored. Thus, generating and storing derived profile data for a tenant profile data not only lead to significant additional memory and processing requirements, but it also resulted in a continual need to create historical snapshots of profile data since the derived data is likely to change over time.

To overcome these technical problems, the present disclosure provides a technical solution that eliminates the need for generating and/or storing derived profile data with a profile. Instead, when additional information about a profile is required, algorithms may be developed that make use of the underlying data (e.g., base profile data and/or data provided by the data sources) to generate the required derived data on the fly. This may be achieved by using profile data extensions. Profile data extensions may be generated, as needed, and may be stored separately from profiles, thus eliminating the need to store derived profile data along with the base profile data. This may have the technical advantage of reducing significant memory use and computer processing requirements.

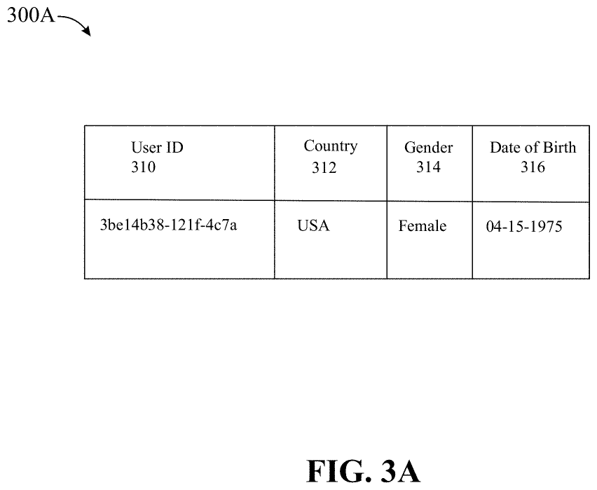

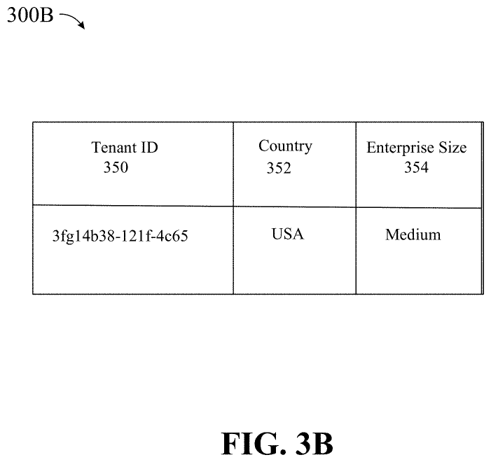

FIGS. 3A-3B depict example improved data profiles for storing data which implement aspects of this disclosure. As shown, the improved user profile 300A may include a variety of data fields such as user ID field 310, country field 312, gender field 314 and date of birth field 316. The data fields 310, 312 314 and 316 may relate to basic information about the user and as such may be referred to as a base profile. Thus, an improved user profile, according to aspects of this disclosure, may primarily include base profile data. As a result, data profiles may be smaller and as such easier to generate, process and store. Furthermore, because base profile data is often directly received from data source systems, as opposed to being derived from other data, it may take less time to generate and process than derived profile data. Thus, the resulting profile is reduced in size, takes less time to generate, and requires reduced computer resources to process. Furthermore, because the data stored in the improved data profile 300A is base data that does not change quickly, it may no longer be necessary to generate and store historical snapshots of each data profile on a regular basis. This not only makes initial data generation and processing more efficient, but it can significantly improve the process of restating data, as further discussed below.

FIG. 3B depicts an example improved tenant profile 300B. Similarly, to the improved user profile 300A, the improved tenant profile 300B includes fewer data fields than prior art data profiles (e.g., data profile 200B). The improved tenant profile 300B may include a tenant ID field 350, country field 352, and enterprise size field 354. These data fields may relate to basic information about a tenant which can often be directly collected from a data source system. As such, the tenant profile 300A may primarily include base profile data that is relatively static and unlikely to change over a short period of time. Like the user profile 300A, the resulting improved profile 300B is smaller, easier to generate and process and may not require frequent historical snapshots. Thus, by utilizing the technical solution, data processing and storage in computer systems can be significantly improved.

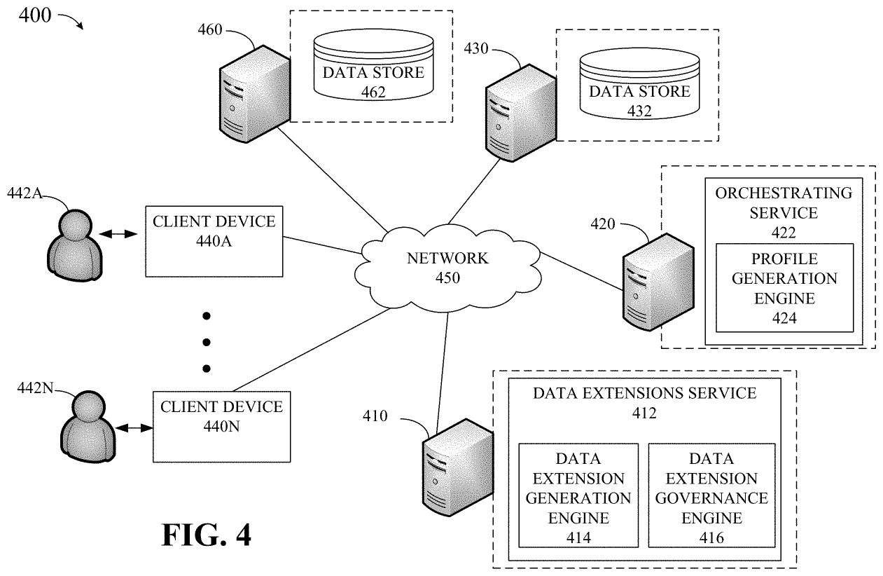

FIG. 4 depicts an example system upon which aspects of this disclosure may be implemented. In different implementations, the system 400 may include a data extensions server 410, an orchestrator server 420, a storage server 430, and a source server 460. The data extensions server 410 may include and/or execute a data extensions service 412, while the orchestrator server 420 may include and/or execute an orchestrating service 422. The storage server 430, on the other hand, may include a data store 432. The data store 432 may function as a repository in which multiple data profiles may be stored. The data source server 460 may represent a data source system which includes one or more data sources. The data sources may include transactional and/or provisioning data sources and may be stored in one or more data stores such as the data store 462. Each of the data sources may include their data store and may contain a variety of sets of data.

Each of the servers 410, 420, 430 and 460 may operate as shared resource servers located at an enterprise accessible by various computer client devices such as client devices 440A through 440N. Each of the servers 410, 420, 430 and 460 may also operate as cloud-based servers for offering global data extension, orchestrating, storage and data source services, respectively. Although shown as one server, each of the servers 410, 420, 430 and 460 may represent multiple servers for performing various operations. For example, the server 420 may include one or more processing servers for performing different orchestrating operations. In another example, the storage server 430 may include or represent multiple storage servers, each having one or more data stores for storing data. Furthermore, although shown as separate servers, two or more of the servers 410, 420, 430 and 460 may be combined into one server. For example, the servers 420 and 410 may be combined such that orchestrating and data extension services 422 and 412 are offered by the same server.

The orchestrating service 422 may function as a data orchestrator responsible for managing, organizing, combining and/or transforming data that is stored in one or more data storage locations. In some implementations, the orchestrating service 422 is responsible for initiating retrieval of data from the data source server 460 and organizing the data into one or more data profiles. This may be done by utilizing a profile generation engine 424. The profile generation engine 424 may include logic for retrieving data from a data source system, identifying a unique data entity key associated with the data, and organizing the data into one or more data profiles each having its own data entity key. The generated profile may be a base data profile which is generated based on data directly provided by a data source such as a data provisioning source. Because, the generated profile may be a base data profile, the amount of processing and memory required to retrieve, process and store the data profile is less than prior art data profiles which include both base data and derived data.

In some implementations, base data profiles may be generated and/or stored frequently, for example, based on a schedule (e.g., once a week). However, because the data stored in a base data profile is not likely to change often and because it is available in the data source, creating historical snapshots of such data profiles may no longer be necessary. Instead, when a data profile for a given time period is needed, the data may be retrieved and organized into the data profile.

A data profile may be generated, when the orchestrator service 422 receives a request for a data profile, retrieves the data from the data source server 460 and organizes the data profile in accordance with the specified request. In an example, the request includes the fields of data required and the format in which they are stored (e.g., tabular format including one or more columns). The fields of data for which data is retrieved may be specified by a user (e.g., an engineering team member). For example, the user may specify a request for consumer user profiles from Mar. 31, 2021 and specify that the requested fields include country, age, gender, and the like. In another example, the request may simply specify the type of data profile (e.g., consumer user, commercial user, tenant, etc.) and all available data associated with such entity may be retrieved from the data source and organized into one or more data profiles automatically by the orchestrating service 422.

The data extension service 412 offered by the data extension server 410 may provide a data extension infrastructure for utilizing profile data extensions to provide access to derived or inferred profile data. As such, the data extension service 412 may be responsible for retrieving, managing, organizing, and/or providing access to derived or inferred profile data. Profile data extension may refer to a data profile, which includes properties (e.g., data fields) that contain derived and/or inferred data.

In some implementations, the data extension service 412 provides a tool offered to users via which they can initiate a request for access to derived or inferred profile data, review the status of their request, receive access to the profile data extensions, and the like. For example, the data extensions service 412 may provide a user interface screen via which the user can submit a request for a particular data extension. This may enable any engineering team to submit a request for access to a profile data extension. In some implementations, a manual review and approval of requests for access to profile data extensions is required, to comply with privacy and ethical guidelines and ensure access is authorized. In some implementations, a request for generating a profile data extension may be submitted automatically, for example, by an application and/or when it is determined that the profile data extension is needed for generating a dependent dataset.

The request for the profile data extension may include one or more rules for generating the data. Alternatively, the request may include the type of data required and the data extension service 412 may determine the rules needed for deriving and/or inferring the required data. For example, the sales team in an organization may for require data on all tenants that do not have a subscription to application A, but do have a subscription to application B. The data extension generation engine 414 of the data extension service 412 may receive the request and intelligently determine that to provide this data, two types of tenant profile extensions may be needed, each having different rules. The first extension may be based on the rule of does tenant have application A, with the possible answers being true or false. Similarly, the second extension may be based on the rule of does tenant have application B with the possible answers being true or false. The rules may then be applied by the data extension generation engine 414 to the available tenant profiles (e.g., tenant profiles generated by the orchestrating service 422 and/or stored in the data store 432) to retrieve a list of tenants who meet the required criteria. The information provided by these profile extensions does not need to be stored with the tenant profiles and as such does not increase the size of the profiles. Yet, when needed, the information may be retrieved, stored and provided for access separate from the base data profile.

In another example, a business unit may require data on the churn propensity score for tenants (or a specific group of tenants). The business unit may need this data to be updated daily and be made available as a property in the tenant profile. Previously, this would require that a data field be added to the tenant data profile. This would add a column to the tenant profile data, increasing its size and thus increasing the processing and memory resources needed to store and process the tenant profile data. Using the data profile extensions mechanisms, this may be achieved by running a model for every tenant, where the model combines properties available in subscription data profiles with usage data for services each Tenants has licensed, and outputs a churn propensity score every day. Thus, the requested data may be inferred from underlying base profile data. The model may be run daily to provide the updates required. The resulting data may be stored as a tenant profile extension which includes churn propensity as a data field with valid scores being 1, 2, 3, 4, 5 or null. This tenant profile extension may be created and stored separately from the base profile. Thus, profile data extensions can be created for a variety of different reasons and can enrich the value and usefulness of the underlying profile data without increasing the size of the base data profile.

The rules for generating each profile data extension may be determined and provided by a user and/or may be generated automatically. For example, one or more machine-learning models and/or data science algorithms may be used to process requests for profile data extension by generating one or more rules that correspond with the profile data extension. Once a request for a profile data extension is received, the data extension generation engine 414 may identify the extension property or properties to which the request relates, determine the type of profile associated with the request (e.g., user profile, tenant profile, etc.), determine if the property is a new property or a proposed enrichment, and decide if the property overrides an existing profile property. The data extension generation engine 414 may then identify the intended inference logic for the requested profile data extension. Furthermore, the data extension generation engine 414 may identify the data source for the extension data (e.g., via the orchestrating service 422). In some implementations, the data extension generation engine 414 may examine the request and automatically create the schema for the profile data extension. Alternatively, and/or additionally, some of the information for the schema may be provided by the requesting user and by manually by a user responsible for managing the profile data extension infrastructure. The schema may include column names, data type for each column, join key, publish classification, data source, property type, measure category, property category, dimension type, refresh frequency and/or default values.

To generate a profile data extension, the data extension generation engine 414 may access and/or retrieve metadata available in the data source server 460 (e.g., metadata available about consumer users in the provisioning source system). That is because the data source server 460 may maintain metadata about the data profiles to which the profile data extension relates. The metadata may include raw data streams from which data profiles are generated. The metadata may be stored and maintained in the data source server and may be accessible by the data extension generation engine 414 either directly or via the orchestrating service 422. For example, the data extension generation engine 414 may send a request for data to the orchestrating service 422, which may, in turn, retrieve the requested data from the data source server 460. Thus, the data extension generation engine 414 may submit a query referencing a type of data entity key (e.g., user ID) and requesting metadata associated with the queried type of data entity key from the data source server 460. Data mapping, retrieval, collection, management and/or any required calculations may then be done at runtime. As a result, the data extension generation engine 414 may generate requested data profile extensions in real-time on the fly.

This provides the technical advantage of enabling the system 400 to federate development of new profile features. A desired change to a data profile may thus be made by making modifications to existing data profile extensions and/or generating a new data profile extension. Instead of having to restate data profiles (e.g., restating historical data), changes to definition of workloads or data fields, or adding new data fields, may be achieved by modifying an existing data profile extension or generating a new one. This can significantly reduce the processing resources required for modifying how data is organized (e.g., changing the definition of a data field, adding a data field, etc.). In the past, any such change would require modifying the mapping files used to generate data for data profiles and restating the historical snapshots for a given period. Because restatement is a serialized process that requires upstream datasets to be restated first, a simple change to a data profile could take a long time to process. This results in significant latency, when a change required. In an example, a change to a workload definition could take weeks to implement. By using data profile extensions, the need for restating historical data may be reduced or eliminated, resulting in reduced processing time and resources.

To ensure that any generated data profile extension complies with privacy, confidentiality, legal and/or ethical guidelines as well as proper business needs, the data extension service 414 may include a data extension governance engine 416. The data extension governance engine 416 may include logic that ensures requests for data profile extensions comply with all required guidelines and regulations. Additionally, the data extension governance engine 416 may ensure data integrity and reliability by providing for mechanism that allow for manual and/or automatic examination, verification, and approval or rejection of a data profile extension request.

Furthermore, the data extension governance engine 416 may facilitate the ability to provide access control for data profile extensions. In some implementations, this is achieved by utilizing a publication classification category for each data profile extension. The publication classification categories may include prototype, preview, tier 1, tier 2, tier 3, and the like. Each of these categories may allow specific group of users to access the data profile extension. For example, the prototype category of data profile extension may be made available only to one or more teams that are responsible for data management and as such have clearance to access the data. Other groups may be defined and/or provided access based on business needs and approved uses of data.

In some implementations, before a new data profile extension is generated and/or is made available for use, it must undergo a final evaluation. The evaluation may be based on one or more exit criteria that ensures any new data property or data profile extension has proper design, testing, documentation and/or access control. The evaluation process may include reviewing the data model, ensuring that the data reconciles to the data source and/or any gaps are defensible, that there are no duplicate or orphan keys in the profile extension data candidate, a source data health check is performed, schema is documented, access control requirements are reviewed and enforce proper controls, compliance classification is completed, and restricted access policies are being implemented and enforced. In some implementations, one or more steps of the final evaluation are performed manually. This may involve going through a checklist of items provided by a tool (e.g., software application) via a user interface screen. In other implementations, some of the steps of the final evaluation are performed automatically, for example, via one or more algorithms provided by the data extension governance engine 416.

The client devices 440A to 440N may include any stationary or mobile computing devices configured to provide a user interface for interaction with a user 442A to 442N and/or configured to communicate via the network 450. For example, the client devices may include workstations, desktops, laptops, tablets, smart phones, cellular phones, personal data assistants (PDA), printers, scanners, telephone, or any other device that can be used to interact with the users 442A to 442N. The client devices 440A to 440N may be representative of client devices used by users (e.g., users 442A to 442N) in a system 400 to monitor, maintain, manage and/or use various data profiles and/or data profile extensions.

It should be noted that, although shown as two different services, the data extensions service 412 and the orchestrating service 422 may be combined into one service. Furthermore, one or more of the functions discussed here as being performed by the data extensions service 412 may be performed by the orchestrating service 422, and vice versa.

Various elements of the system 400 may be connected to each other via the network 450. For example, each of the servers 410, 420, 430 and 460 may be connected to one another via the network 450. Similarly, the client devices 440A through 440N may be connected to the orchestrating server 410 and/or data extensions server 420 via the network 450. The network 450 may be a wired or wireless network or a combination of wired and wireless networks.

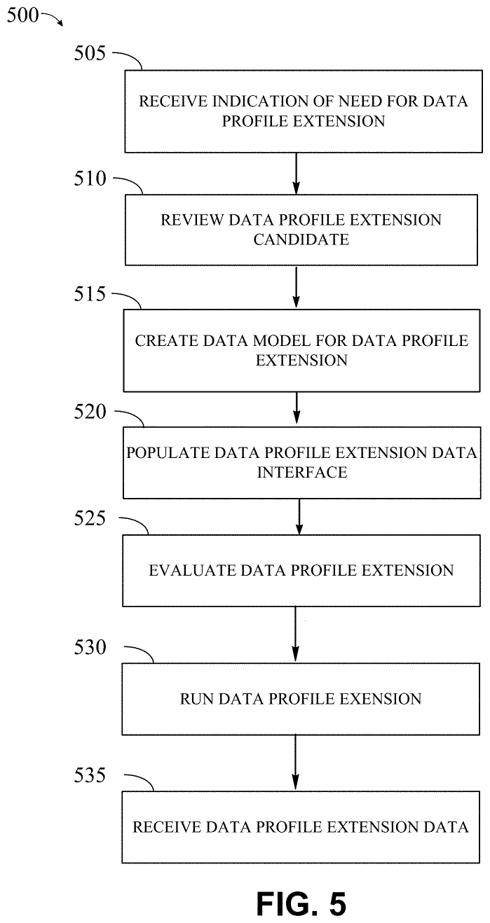

FIG. 5 is a flow diagram depicting an example method 500 for enabling user of data profile extensions in a data environment. In an example, one or more steps of method 500 may be performed by a data extensions server (e.g., data extensions 410 of FIG. 4) or orchestrating server (e.g., orchestrating server 420 of FIG. 4). Other steps of method 500 may be performed by a storage server or data source server (e.g., storage server 430 or data source server 460 of FIG. 4).

At 505, the method 500 may begin by receiving an indication of a need for a data profile extension. The indication may be received when a user, such as an engineering team member or sales team member transmits a request for access to a specific data (e.g., users that are subscribed to application A). Additionally, the indication may be received when a change to an existing data profile or dataset is required because of changing business or engineering needs. For example, when a change to a definition of a workload is required. Furthermore, the indication may be received when a request for restating a historical snapshot of a data profile is received. That is because by using the data profile extensions infrastructure, restatement of data may be done on the fly, as further discussed below.

After receiving the indication of need for a data profile extension, method 500 may proceed to review the data profile extension candidate, at 510. This may involve examining the request, the type of data profile it relates to, the type of data source it is associated and/or whether or not the use of data profile extensions is possible or appropriate for the type of data needed. This may be done manually by going through a checklist of items that need to be reviewed. Alternatively, one or more steps of this process may be done automatically without human intervention.

Once the data profile extension candidate has been reviewed and approved, method 500 may proceed to create a data model for the data profile extension, at 515. This may involve utilizing one or more algorithms or ML models to create data rules that when executed in the appropriate data environment generate the required data. In some implementations, the data model is provided with the request and/or created manually. Alternatively, the data model is generated automatically without human intervention.

After the data model for the data profile extension is created, method 500 may proceed to populate a data profile extension profile interface for the new data profile extension, at 520. This may involve creating a schema for the data profile extension, providing a name for the data profile extension, indicating a time period associated with the data profile extension (e.g., availability date of the extension, time period for which data is being collected, etc.), and/or indicating the name of the data profile to which the extension is being applied (e.g. tenant profile, consumer user profile, etc.). In some implementations, this involves populating an extension data profile interface JSON. One or more steps of this process may be done automatically or manually.

Once the required interface is completed, method 500 may proceed to evaluate the data proposed data profile extension, at 525. This may involve evaluating the data profile extension to ensure it complies with all required guidelines, that a proper publication classification has been assigned to the data profile extension, and/or exit criteria has been reviewed and complied with. When, it is determined that the data profile extension meets all required qualifications, method 500 may proceed to execute the data profile extension, at 530. This may involve exposing the extension in approved surfaces and/or scenarios. It may also include retrieving data from one or more base data profiles and/or data sources to generate the data profile extension. Once, the data profile extension has been generated and the required data collected, method 500 may receive the data profile extension data, at 535. This may include receiving access to the data profile extension data. In some implementations, the generated data profile extension data may be stored locally or at a data store and a link to its location may be provided to one or more users.

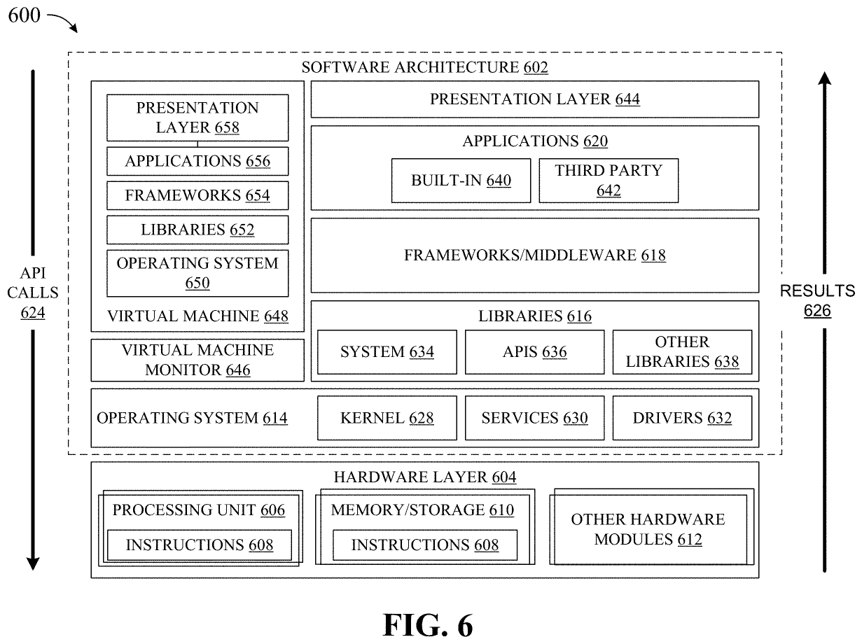

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

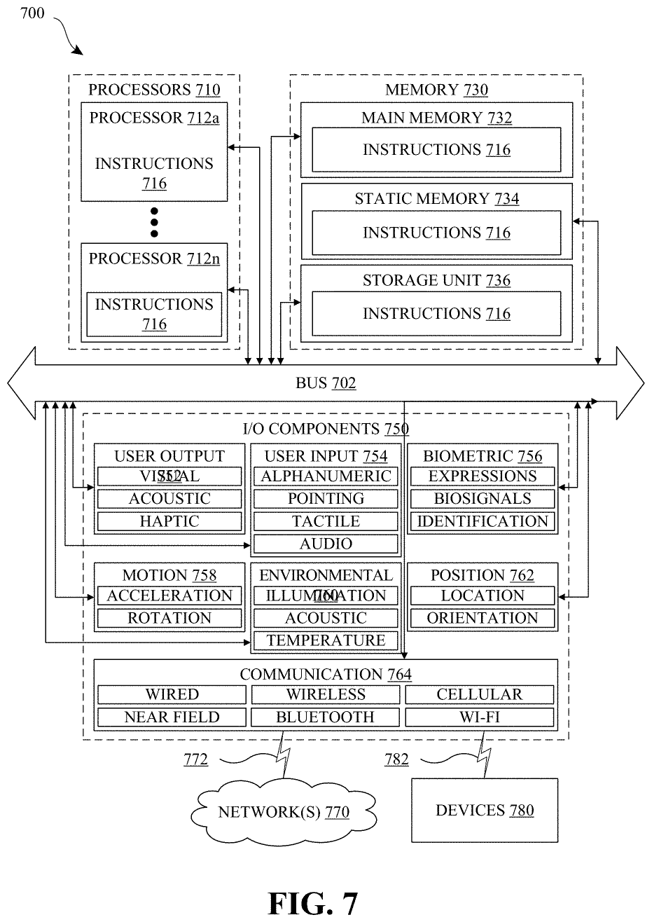

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram showing components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The examples of I/O components illustrated in FIG. 7 are not limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:

a processor; and

a memory in communication with the processor, the memory comprising executable instructions that, when executed by the processor, cause the data processing system to perform functions of:
receiving a request for historical data, the data being associated with a first data profile, the first data profile being generated from data supplied by a data source system;
responsive to the received request, creating a data model for obtaining the historical data based on data from at least one of the first data profile, a second data profile, or the data source system;
executing the data model to obtain the historical data; and storing the historical data as a data extension of the first data profile;
wherein:
   the first data profile and the data extension of the first data profile are generated and stored separately, and
   the data extension of the first data profile is generated dynamically at runtime.

Item 2. The data processing system of item 1, wherein the memory further stores executable instructions that, when executed by the processor, cause the data processing system to receive a request to restate data associated with the first data profile, the data model being created in response to receiving the request to restate data.

Item 3. The data processing system of any preceding item, wherein the request is associated with a change to a data structure of the first data profile.

Item 4. The data processing system of any preceding item, wherein the memory further stores executable instructions that, when executed by the processor, cause the data processing system to evaluate the data model for compliance with at least one of access control policies and privacy policies.

Item 5. The data processing system of any preceding item, wherein the memory further stores executable instructions that, when executed by the processor, cause the data processing system to populate a data profile extension interface.

Item 6. The data processing system of any preceding item, wherein the first data profile includes base data associated with the first data profile.

Item 7. The data processing system of any preceding item, wherein the data extension of the first data profile includes at least one of derived or inferred data associated with the first data profile.

Item 8. A method for providing generating data extensions for a first data profile comprising:
receiving a request for historical data, the data being associated with a first data profile, the first data profile being generated from data supplied by a data source system;
responsive to the received request, creating a data model for obtaining the historical data based on data from at least one of the first data profile, a second data profile, or the data source system;
executing the data model to obtain the historical data; and
storing the historical data as a data extension of the first data profile;
wherein:
   the first data profile and the data extension of the first data profile are generated and stored separately, and
   the data extension of the first data profile is generated dynamically at runtime.

Item 9. The method of item 8, further comprising receiving a request to restate data associated with the first data profile, the data model being created in response to receiving the request to restate data.

Item 10. The method of items 8 or 9, wherein the request is associated with a change to a data structure of the first data profile.

Item 11. The method of any of items 8-10, further comprising evaluating the data model for compliance with at least one of access control policies and privacy policies.

Item 12. The method of any of items 8-11, further comprise populating a data profile extension interface.

Item 13. The method of any of items 8-12, wherein the first data profile includes base data associated with the first data profile.

Item 14. The method of any of items 8-13, wherein the data extension of the first data profile includes at least one of derived or inferred data associated with the first data profile.

Item 15. A non-transitory computer readable medium on which are stored instructions that when executed cause a programmable device to:
receive a request for historical data, the data being associated with a first data profile, the first data profile being generated from data supplied by a data source system;
responsive to the received request, create a data model for obtaining the historical data based on data from at least one of the first data profile, a second data profile, or the data source system;
execute the data model to obtain the historical data; and
store the historical data as a data extension of the first data profile;
wherein:
   the first data profile and the data extension of the first data profile are generated and stored separately, and
   the data extension of the first data profile is generated dynamically at runtime.

Item 16. The non-transitory computer readable medium of item 15, wherein the instructions further cause the programmable device to receive a request to restate data associated with the first data profile, the data model being created in response to receiving the request to restate data.

Item 17. The non-transitory computer readable medium of items 15 or 16, wherein the instructions further cause the programmable device to perform a function of evaluating the data model for compliance with at least one of access control policies and privacy policies.

Item 18. The non-transitory computer readable medium of any of items 15-17, wherein the instructions further cause the programmable device to perform a function of populating a data profile extension interface.

Item 19. The non-transitory computer readable medium of any of items 15-18, wherein the first data profile includes base data associated with the first data profile.

Item 20. The non-transitory computer readable medium of any of items 15-19, wherein the data extension of the first data profile includes at least one of derived or inferred data associated with the first data profile.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
receiving a request for historical data, the data being associated with a first data profile, the first data profile being generated from data supplied by a data source system;
responsive to the received request, creating a data model for obtaining the historical data based on data from at least one of the first data profile, a second data profile, or the data source system;
executing the data model to obtain the historical data; and
storing the historical data as a data extension of the first data profile;
wherein:
the first data profile and the data extension of the first data profile are generated and stored separately, and
the data extension of the first data profile is generated dynamically at runtime.

2. The data processing system of claim 1, wherein the memory further stores executable instructions that, when executed by the processor, cause the data processing system to receive a request to restate data associated with the first data profile, the data model being created in response to receiving the request to restate data.

3. The data processing system of claim 1, wherein the request is associated with a change to a data structure of the first data profile.

4. The data processing system of claim 1, wherein the memory further stores executable instructions that, when executed by the processor, cause the data processing system to evaluate the data model for compliance with at least one of access control policies and privacy policies.

5. The data processing system of claim 1, wherein the memory further stores executable instructions that, when executed by the processor, cause the data processing system to populate a data profile extension interface.

6. The data processing system of claim 1, wherein the first data profile includes base data associated with the first data profile.

7. The data processing system of claim 1, wherein the data extension of the first data profile includes at least one of derived or inferred data associated with the first data profile.

8. A method for providing generating data extensions for a first data profile comprising:
receiving a request for historical data, the data being associated with a first data profile, the first data profile being generated from data supplied by a data source system;
responsive to the received request, creating a data model for obtaining the historical data based on data from at least one of the first data profile, a second data profile, or the data source system;
executing the data model to obtain the historical data; and
storing the historical data as a data extension of the first data profile;
wherein:
the first data profile and the data extension of the first data profile are generated and stored separately, and
the data extension of the first data profile is generated dynamically at runtime.

9. The method of claim 8, further comprising receiving a request to restate data associated with the first data profile, the data model being created in response to receiving the request to restate data.

10. The method of claim 8, wherein the request is associated with a change to a data structure of the first data profile.

11. The method of claim 8, further comprising evaluating the data model for compliance with at least one of access control policies and privacy policies.

12. The method of claim 8, further comprise populating a data profile extension interface.

13. The method of claim 8, wherein the first data profile includes base data associated with the first data profile.

14. The method of claim 8, wherein the data extension of the first data profile includes at least one of derived or inferred data associated with the first data profile.

15. A non-transitory computer readable medium on which are stored instructions that when executed cause a programmable device to:
receive a request for historical data, the data being associated with a first data profile, the first data profile being generated from data supplied by a data source system;
responsive to the received request, create a data model for obtaining the historical data based on data from at least one of the first data profile, a second data profile, or the data source system;
execute the data model to obtain the historical data; and
store the historical data as a data extension of the first data profile;
wherein:
the first data profile and the data extension of the first data profile are generated and stored separately, and
the data extension of the first data profile is generated dynamically at runtime.

16. The non-transitory computer readable medium of claim 15, wherein the instructions further cause the programmable device to receive a request to restate data associated with the first data profile, the data model being created in response to receiving the request to restate data.

17. The non-transitory computer readable medium of claim 15, wherein the instructions further cause the programmable device to perform a function of evaluating the data model for compliance with at least one of access control policies and privacy policies.

18. The non-transitory computer readable medium of claim 15, wherein the instructions further cause the programmable device to perform a function of populating a data profile extension interface.

19. The non-transitory computer readable medium of claim 15, wherein the first data profile includes base data associated with the first data profile.

20. The non-transitory computer readable medium of claim 15, wherein the data extension of the first data profile includes at least one of derived or inferred data associated with the first data profile.
